(19) United States
(12) Patent Application Publication
(10) Pub. No.: US 2025/0287047 A1
(43) Pub. Date: Sep. 11, 2025

(54) AIRCRAFT CONTENT DISTRIBUTION NETWORK WITH DISTRIBUTED STORAGE SYSTEM

(71) Applicant: Panasonic Avionics Corporation, Irvine, CA (US)

(72) Inventor: Attila SZILAGYI, Santa Ana, CA (US)

(21) Appl. No.: 18/601,814

(22) Filed: Mar. 11, 2024

(51) Int. Cl. H04N 21/214; H04N 21/218; H04N 21/2183

(52) U.S. Cl. CPC H04N 21/2146; H04N 21/2181; H04N 21/2183

(57) ABSTRACT

A content distribution network (CDN) network with a distributed storage system, and associated devices and methods, are disclosed herein. In some implementations, a content distribution network system for an aircraft includes onboard servers and in-flight-entertainment (IFE) devices on the aircraft. Each onboard server can include central applications, a first CDN node, and a central database operably. Each IFE device can include IFE applications, a second CDN node, and an IFE database. The central databases and the IFE databases can form a distributed storage system that is configured to store multimedia content and/or packets of multimedia content in one or more of the central databases and/or the IFE databases. The central applications can be configured to access the distributed storage system via the first and/or second CDN nodes, and the IFE applications can be configured to access the distributed storage system via the first and/or second CDN nodes.

### TECHNICAL FIELD

This patent document is directed generally to systems, methods, and apparatuses for managing a content distribution network with a distributed storage system onboard an aircraft.

### BACKGROUND

Commercial aircraft today often include in-flight entertainment (IFE) devices that can interact with passengers to provide various forms of entertainment (e.g., movies, music, TV shows, etc.), flight-tracking programs, and other services. The multimedia content and software applications providing those services are often stored on ground-based servers and onboard servers physically on the aircraft. However, accessing data stored in ground-based servers requires connectivity and sufficient bandwidth, which is hardly guaranteed on commercial aircraft. Moreover, onboard servers can be costly and limited in storage space, making it difficult to store all of the data locally on the aircraft. Therefore, there is a need for an improved storage system that can simultaneously accommodate larger amounts of data and provide such data in a reliable manner.

### SUMMARY

An aircraft-based content distribution network that includes a distributed storage arrangement are disclosed.

In one example aspect, a content distribution system is disclosed. The system includes one or more onboard servers on the aircraft, each of the onboard servers comprising one or more central applications; a first content distribution network (CDN) node operably coupled to the one or more central applications; and a central database operably coupled to the first CDN node; and one or more in-flight-entertainment (IFE) devices on the aircraft. Each of the IFE devices comprises one or more IFE applications; a second CDN node operably coupled to the one or more IFE applications; and an IFE database operably coupled to the second CDN node. The central databases and the IFE databases form a distributed storage system. The distributed storage system is configured to store multimedia content and/or packets of multimedia content in one or more of the central databases and/or the IFE databases. The one or more central applications are configured to access the distributed storage system via the first and/or second CDN nodes. The one or more IFE applications are configured to access the distributed storage system via the first and/or second CDN nodes.

In another aspect, a distributed storage system onboard an aircraft is disclosed. The system includes one or more central databases included in one or more onboard servers on the aircraft, wherein the central databases are operably coupled to a first content distribution network (CDN) node included in the one or more onboard servers; and one or more in-flight entertainment (IFE) databases included in one or more IFE devices on the aircraft, wherein the IFE databases are operably coupled to a second CDN node included in the one or more IFE devices, wherein the one or more central databases and the one or more IFE databases are configured to store multimedia content and/or packets of multimedia content, and wherein the one or more central databases and the one or more IFE databases are configured to provide requested content to applications included in at least one of the one or more onboard servers or the one or more IFE devices via the first and/or second CDN nodes.

In yet another aspect, a method of operating a content distribution network system (is disclosed. The method includes receiving a request for content from an application onboard the aircraft; accessing a distributed storage system on the aircraft, wherein the distributed storage system comprises: one or more central databases included in one or more onboard servers on the aircraft; and one or more in-flight entertainment (IFE) databases included in one or more IFE devices on the aircraft; retrieving the requested content from at least one of the central databases and/or the IFE databases of the distributed storage system; and transferring the retrieved content to the application.

In yet another aspect, a hardware platform comprising at least one processor for implementing the above-described method is disclosed.

In yet another aspect, a computer-readable medium (CRM) is disclosed. The CRM stores code, which, upon execution by one or more processors, causes the one or more processor to implement the above-described method.

These, and other, aspects are further described throughout the present document.

### BRIEF DESCRIPTION OF THE DRAWINGS

Features, aspects, and advantages of the presently disclosed technology may be better understood with regard to the following drawings.

FIG. 1 shows an example of in-flight entertainment (IFE) devices installed in an airplane based on some implementations of the disclosed technology.

FIG. 2 shows an example block diagram of a computing device based on some implementations of the disclosed technology.

FIG. 3 is a schematic diagram of a content distribution network with a distributed storage system based on some implementations of the disclosed technology.

FIG. 4 is a flowchart illustrating a method for operating a content distribution network system for an aircraft based on some implementations of the disclosed technology.

A person skilled in the relevant art will understand that the features shown in the drawings are for purposes of illustrations, and variations, including different and/or additional features and arrangements thereof, are possible.

### DETAILED DESCRIPTION

Various implementations will be discussed in detail with reference to the figures below. In the description, the technology is described with respect to aircraft such as commercial planes, but the implementations of the disclosed technology can be applicable to other vehicles such as jets, buses, trains, ships, and other types of passenger vehicles.

### 1. Introduction

Various implementations of the disclosed technology provide techniques for expanding the effective amount of total storage space onboard an aircraft for storing multimedia content and other forms of data. Multimedia content (e.g., movies, music, TV shows, etc.), flight data, cabin data, software applications for processing such content and data, etc. are conventionally stored on ground-based servers and onboard servers physically on the aircraft. However, accessing data stored in ground-based servers from an aircraft in-flight requires reliable connectivity and sufficient bandwidth, which is hardly guaranteed. Relying on onboard servers can be similarly problematic, as airplanes have limited space, cooling, and power for maintaining such onboard servers. Moreover, onboard servers can be costly to install and maintain, making it difficult to store all of the data locally on the aircraft. Furthermore, the amount of data demanded and the content access speed expected by passengers continue to increase. Therefore, there is a growing need for an improved storage system on aircraft that can simultaneously accommodate larger amounts of data and provide such data in a reliable manner.

In some implementations of the present technology, a content distribution network system for an aircraft includes one or more onboard servers and one or more in-flight-entertainment (IFE) devices on the aircraft. Each of the onboard servers can include one or more central applications, a first content distribution network (CDN) node operably coupled to the one or more central applications, and a central database operably coupled to the first CDN node. Each of the IFE devices can include one or more IFE applications, a second CDN node operably coupled to the one or more IFE applications, and an IFE database operably coupled to the second CDN node. The central databases and the IFE databases can form a distributed storage system that is configured to store multimedia content and/or packets of multimedia content in one or more of the central databases and/or the IFE databases. The central applications can be configured to access the distributed storage system via the first and/or second CDN nodes, and the one or more IFE applications can be configured to access the distributed storage system via the first and/or second CDN nodes.

In some implementations, a distributed storage system onboard an aircraft includes one or more central databases included in one or more onboard servers on the aircraft, and one or more in-flight entertainment (IFE) databases included in one or more IFE devices on the aircraft. The central databases can be operably coupled to a first content distribution network (CDN) node included in the one or more onboard servers, and the IFE databases can be operably coupled to a second CDN node included in the one or more IFE devices. The one or more central databases and the one or more IFE databases can be configured to store multimedia content and/or packets of multimedia content, and provide requested content to applications included in at least one of the one or more onboard servers or the one or more IFE devices via the first and/or second CDN nodes.

### 2. Examples of Aircraft-Based CDNs

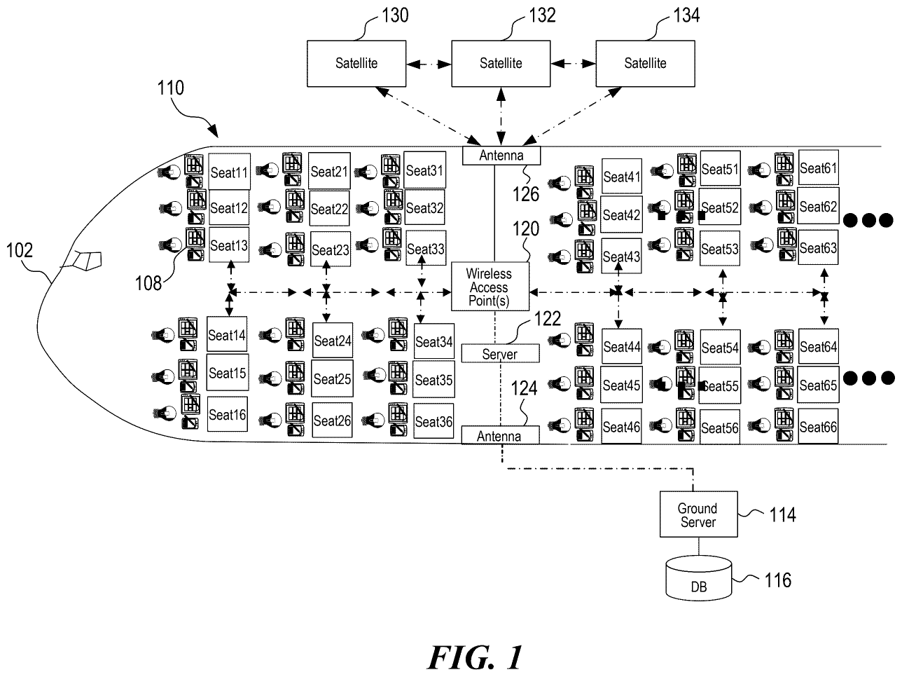

FIG. 1 shows an example of a content distribution network (CDN) 110 for an airplane 102 based on some implementations of the disclosed technology. The CDN 110 includes a plurality of in-flight entertainment (IFE) devices 108, which can provide various entertainment and connectivity services, including video and audio streaming and Internet communications, to passengers on board. For example, the IFE devices 108 can include such as monitors, handsets, ports for transferring audio/power/data, etc. The IFE devices 108 can also communicate or otherwise interact with personal electronic devices (PEDs) carried by passengers. PEDs may refer to any electronic computing device that includes one or more processors or circuitries for implementing the functions related to data storage, video and audio streaming, wired communications, wireless communications, etc. Examples of the PEDs include cellular phones, smart phones, tablet computers, laptop computers, and other portable computing devices. In implementations of the disclosed technology, PEDs may have the capability to execute application software programs (“apps”) to perform various functions and/or communicate with the IFE devices 108.

In the illustrated embodiment, the passenger seats are individually labeled Seat11 to Seat 66. In some implementations, the IFE devices 108 are provided at each passenger seat, such as located at each of the seatbacks of the passenger seats, and/or on cabin walls and/or deployable from an armrest for seats located at a bulkhead (i.e., in the first row of a section). The IFE devices 108 can include displays providing interfaces to each passenger through which each passenger enters their selections on the entertainment option, e.g., the particular selections, emergency requests, etc. Upon receiving the selection from the passengers, based on the selections from the passengers, the IFE devices 108 can display entertainment content and travel information.

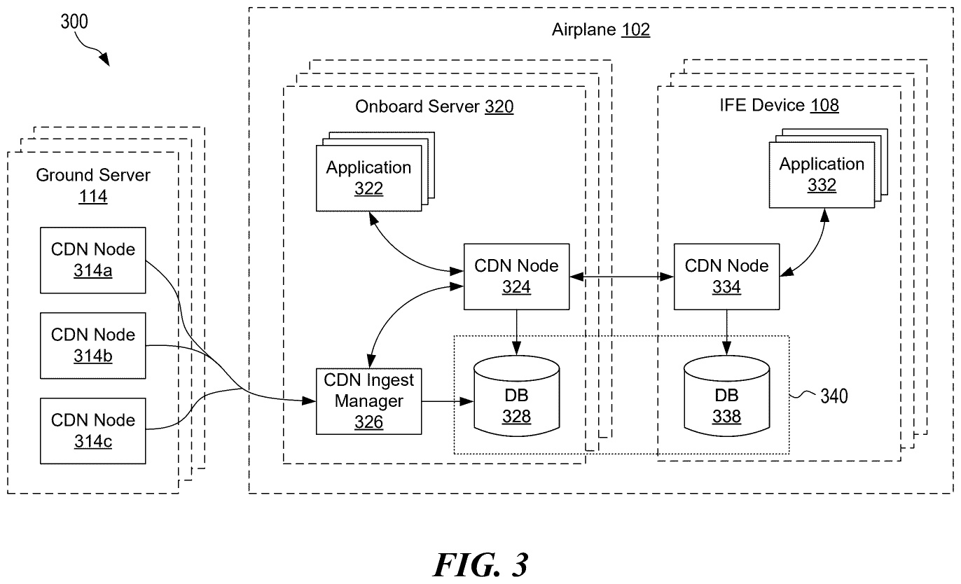

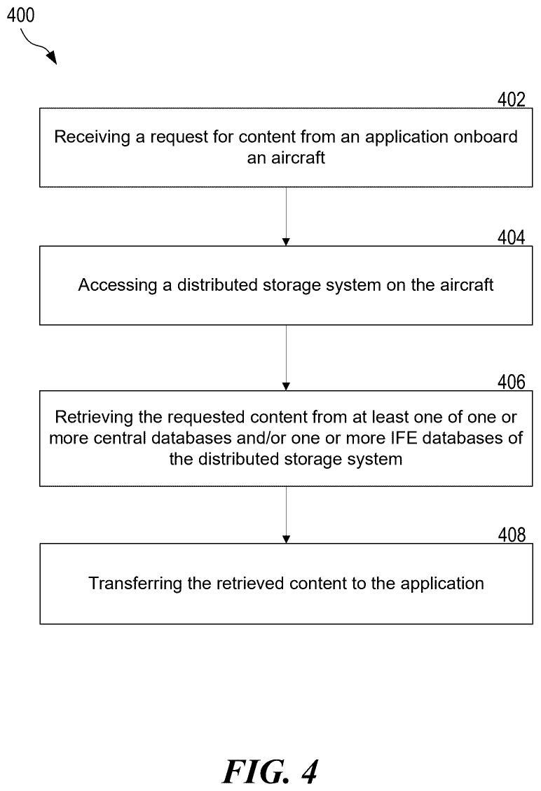

The CDN 110 can also include one or more onboard servers 122 communicably coupled to the IFE devices 108 and/or the PEDs via one or more wireless access points 120. The onboard servers 122 can perform various operations including transferring and managing data as discussed with reference to FIGS. 3 and 4. The communications between the servers 122, the IFE devices 108, and the PEDs are realized by wired and/or wireless connections. In some implementations, the communication among the servers 122, the IFE devices 108, and the PEDs are achieved through the antenna 124 to and from a ground-based server 114 and/or ground-based cell towers by, for example, a provision of network plugs at the seat for the IFE devices 108 to a wired onboard local area network. In some other implementations, the communications among the servers 122, the IFE devices 108, and the PEDs are achieved through the antenna 126 to and from satellites 130, 132, 134 in an orbit (e.g., via a cellular network utilizing one or more onboard base station(s), Wi-Fi utilizing the wireless access point 120, and/or Bluetooth).

The servers 122, the IFE devices 108, and the PEDs form a local network part of the CDN 110 onboard the airplane 102 through an onboard router (not shown). The servers 122 are also communicably coupled with the ground server 114 through the antenna 124 for receiving and transmitting information from/to the ground server 114. The ground server 114 can be located at various locations, such as a computer center at an arbitrary location on the ground, etc. The ground server 114 may be in communication with a database 116, provide information from the database 116 to the server 122, and store information received from the server 122 in the database 116. Although FIG. 1 shows that the database 116 is provided separately from the ground server 114, the database 116 can be provided as a part of the ground server 114.

### 3. Examples of Hardware Platforms

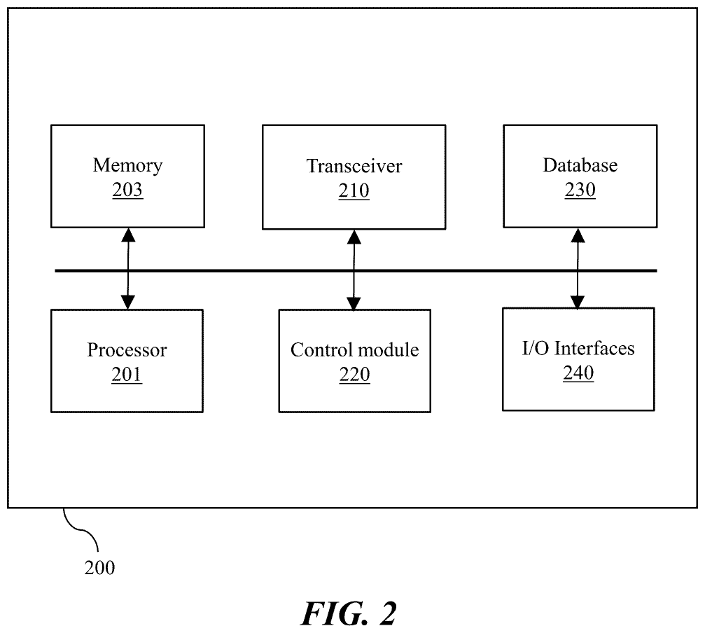

FIG. 2 shows an example block diagram of a computing device 200 (e.g., an onboard server, a ground server, or a portable server) based on some implementations of the disclosed technology. The computing device 200 includes at least one processor 201, a memory 203, a transceiver 210, a control module 220, a database 230, and an input/output (I/O) interface 240. In other embodiments, additional, fewer, and/or different elements may be used to configure the computing device 200. The memory 203 may store instructions and applications to be executed by the processor 201. The memory 203 is an electronic holding place or storage for information or instructions so that the information or instructions can be accessed by the processor 201. The memory 203 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 201 configure the computing device 200 to perform the operations (e.g., the operations as shown in and described with reference to FIGS. 3 and 4), which will be described in this patent document. The instructions executed by the processor 201 may be carried out by a special purpose computer, logic circuits, or hardware circuits. The processor 201 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 201 can perform the operations called for by that instruction.

The processor 201 operably couples with the memory 203, the transceiver 210, the control module 220, the database 230, and the I/O interface 240, to receive, send, and process information and to control the operations of the computing device 200. The processor 201 may retrieve a set of instructions from a permanent memory device, such as a ROM device, and copy the instructions in an executable form to a temporary memory device that is generally some form of RAM. In some implementations, the computing device 200 can include a plurality of processors that use the same or a different processing technology. The transceiver 210 may include a transmitter and a receiver. In some embodiments, the device 200 comprises a transmitter and a receiver that are separate from one another but functionally form a transceiver. The transceiver 210 transmits or sends information or data to another device (e.g., the IFE devices 108, a reader device, etc.) and receives information or data transmitted or sent by another device (e.g., another server, a PAD, etc.).

The control module 220 of the computing device 200 is configured to perform operations to assist the computing device 200. In some implementations, the control module 220 can be configured as a part of the processor 201. When the computing device 200 communicates with the IFE devices 108 in FIG. 1, the control module 220 can be included in the airplane 102. In some implementations, the control module 220 can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module 220 may assist the computing device 200 to perceive their environment and take actions that maximize the effectiveness of the operations performed by the computing device 200.

The I/O interfaces 240 enable data to be provided to the computing device 200 as input and enable the computing device 200 to provide data as output. In some embodiments, the I/O interfaces 240 may enable user input to be obtained and received by the computing device 200 (e.g., via a touch-screen display, buttons, or switches) and may enable the computing device 200 to display information. In some embodiments, devices, including touch screen displays, buttons, controllers, audio speakers, or others, are connected to the computing device 200 via I/O interfaces 240.

In some implementations, the computing device 200 comprises a computer-readable medium (e.g., the memory 203) including processor instructions that, when executed by one or more processors (e.g., the processor 201), cause the one or more processors to perform data storage, transfer, and management processes as described in further detail below with reference to FIGS. 3 and 4. In some embodiments, the computing device 200 may be used as a hardware platform for the CDN node 324 or 334.

### 4. Examples of Virtualized CDN Operation

FIG. 3 is a schematic diagram of a content distribution network (CDN) system 300 with a distributed storage system 340 based on some implementations of the disclosed technology. The CDN system 300 can be an example of the CDN 110 illustrated in and described above with reference to FIG. 1. In the illustrated embodiment, the CDN system 300 includes one or more onboard servers 320 physically located on the aircraft 102, one or more IFE devices 108 also physically located on the aircraft 102, and one or more ground servers 114 located off board the aircraft 102.

Each ground server 114 can include one or more CDN nodes (individually labeled 314a, 314b, 314c, collectively referred to as “the CDN nodes 314”). The CDN nodes 314 can be operably coupled to or otherwise associated with ground-based databases (not shown) and/or can connect to the Internet.

Each onboard server 320 can include one or more central applications 322, a CDN node 324, a CDN ingest manager 326, and a central database 328. The central applications 322 can include a wide range of programs that provide in-flight entertainment (e.g., movies, music, TV shows), support flight operations (e.g., providing navigation and weather data), assist flight crew members (e.g., allowing communication with passengers, checking various statuses), and more. The CDN node 324 can include a device or point through which data is transferred and/or processed. In some implementations, the CDN node 324 is a virtual storage instance that can interact with other nodes in a networked environment, as discussed in further detail below. The CDN ingest manager 326 can include a logic, processor, or other component with a decision-making algorithm, and a communication module. In some implementations, the CDN ingest manager 326 includes an artificial intelligence and/or machine learning model. In some implementations, at least one of the onboard servers 320 includes the CDN ingest manager 326, which can be operably coupled to the CDN node 324 and the central database 328 of one or more of the onboard serves 320. The central database 328 can include one or more hard drives, solid-state drives (SSDs), USB flash drives, memory cards, network-attached storage (NAS) devices, etc.

Each IFE device 108 can include one or more IFE applications 332, a CDN node 334, and an IFE database 338. The IFE applications 332 can include programs specifically designed or configured to run on the IFE devices 108. For example, the IFE applications 332 can include software programs for playing multimedia content, flight tracking, shopping, Internet connectivity, etc. The IFE applications 332 can also manage user interfaces that allow passengers to select which of the central applications 322 and/or the IFE applications 332 to run on their dedicated IFE device 108. The CDN node 334 can include a device or point through which data is transferred and/or processed. In some implementations, the CDN node 324 is a virtual storage instance that can interact with other nodes in a networked environment, as discussed in further detail below. The IFE database 338 can include one or more hard drives, solid-state drives (SSDs), USB flash drives, memory cards, network-attached storage (NAS) devices, etc.

When storing data onboard the airplane 102, the storage space available on the central databases 328 of the onboard servers 320 and the storage space available on the IFE databases 338 of the IFE devices 108 can be pooled together such that the central databases 328 and the IFE databases 338 form a single virtual disk, referred to as a distributed storage system 340 hereinafter. The distributed storage system 340 can store data by, for example, storing a complete data packet (e.g., an entire movie) in one of the central databases 328 or one of the IFE databases 338, or storing parts of a data packet (e.g., parts of a movie) in multiple ones of the central databases 328 and/or the IFE databases 338. The onboard servers 320 and/or the IFE devices 108, and/or other components on the airplane 102 can include processors configured to perform segmentation and stitching of data packets such that data can be properly stored in pieces and eventually assembled when provided to passengers.

In operation, the CDN system 300 in accordance with implementations of the present technology can receive requests for content or other forms of data and provide such content accordingly. For example, when a passenger submits a request to watch a certain movie to one of the IFE applications 332 (e.g., via a user interface on a display included in the IFE devices 108), the request can be passed from the IFE application 332 to the CDN node 334 and/or the CDN node 324. In some implementations, the CDN node 324 and the CDN node 334 are synchronized such that they can read data from the central database 328 and the IFE database 338, respectively, and determine whether the requested data is fully available on the distributed storage system 340, whether stored on a single database or segmented in multiple databases. If the requested movie is found to be fully available on the distributed storage system 340, the movie can be extracted, copied, or otherwise delivered to the IFE application 332 via the CDN node 324 and/or the CDN node 334.

However, if the requested movie is found not to be fully available on the distribute storage system 340, the CDN node 324 can submit a cache miss request to the CDN ingest manager 326 (e.g., to a communication module included in the CDN ingest manager 326). In response, the CDN ingest manager 326 can communicate (e.g., via the communication module included in the CDN ingest manager 326) with the ground servers 114 to receive the requested movie (or missing parts thereof) from one or more of the CDN nodes 314 of the ground servers 114. In some implementations, the data transfer between the CDN nodes 314 and the CDN ingest manager 326 is done via satellite communication, High Frequency Data Link (HFDL), and/or other forms of wireless communication protocols. After or while receiving the data packets from the CDN nodes 314, the CDN ingest manager 326 can decide whether and/or how to store the data packets in the distributed storage system 340. For example, the CDN ingest manager 326 can determine which database would be appropriate based on the data type, data size, and/or other factors, which databases are available to store additional data, whether one more databases should be offloaded (e.g., remove data from the distributed storage system 340), whether and/or how to segment the data prior to storage, what level of content redundancy to maintain, etc. In some implementations, the CDN ingest manager 326 and the CDN node 324 are synchronized such that they can communicate data transfer progress or other statuses in real-time.

In another example, one of the central applications 322 can make a request for data to the CDN node 324, the CDN node 324 can sync with the CDN node 334 to determine whether the requested data is available on the distributed storage system 340, submit a cache miss request to the CDN ingest manager 326 as needed, and provide the requested data to the central application 322. The steps taken can be generally similar to the steps described above with respect to the requested received from the IFE application 332.

In some implementations, the CDN ingest manager 326 can be configured to anticipate demands for certain types of data, and coordinate with the CDN nodes 314, 324, 334 accordingly. For example, the CDN ingest manager 326 can anticipate what multimedia content the passengers will likely request based on passenger data, the flight route, etc. The CDN ingest manager 326 can then coordinate with the CDN nodes 314, 324, 334 to ensure that the anticipated content is available on the distributed storage system 340 prior to passengers actually making such requests. In some implementations, the CDN ingest manager 326 can include a machine learning model trained on training sets that provide passenger data, flight route data, etc. as inputs and specific requests for content as expected outputs.

The CDN system 300 including the distributed storage system 340 in accordance with implementations of the present technology is expected to significantly improve the experiences of passengers interacting with IFE devices 108, crew members managing flight operations, etc. First, the total available storage space available on the distributed storage system 340 is generally equal to the sum of the storage space available on all of the central databases 328 on the onboard servers 320 and the storage space available on all of the IFE databases 338 on the IFE devices 108. Therefore, using the distributed storage system 340 offers significantly increased storage space available compared to just using the onboard servers 320 for data storage, as conventional aircraft do. This means that a significantly greater amount of multimedia content (and other content) and/or higher quality content (e.g., movies of higher resolutions, flight tracking programs with more detail) can be readily available onboard the airplane 102.

Having more content locally available means that it is less likely that the airplane 102 will need to retrieve requested or anticipated content from the ground servers 114, which may be slow, costly, unreliably, and/or unavailable. Less usage of bandwidth for streaming movies (as an example) also means that more bandwidth remains available for other activities such as passenger Internet browsing. Having more content locally available also translates to reduced overall latency for passengers in receiving the requested content.

Moreover, because the distributed storage system 340 is accessed via the CDN nodes 324, 334, the central applications 322 and the IFE applications 332 need not be modified to adapt to the presence of the distributed storage system 340 on the airplane 102. In other words, the CDN nodes 324, 334 provide a level of abstraction between the applications 322, 332 and the distributed storage system 340 such that the applications 322, 332 can access and benefit from the distributed storage system 340 without even being aware of (e.g., without the need to include compatibility features or add-ons, hardware/software modifications, etc.) the distributed storage system 340.

In addition, in implementations in which the CDN ingest manager 326 is able to anticipate requests for content and pre-store the content anticipated to be in demand on the distributed storage system 340 accordingly, the CDN system 300 is expected to further reduce latency for passengers who eventually make requests for such content.

### 5. Examples of Operating an Aircraft CDN

FIG. 4 is a flowchart illustrating a method 400 for operating a content distribution network system for an aircraft based on some implementations of the disclosed technology. While the method 400 id described below with reference to the embodiments of FIGS. 1-3, those skilled in the art will appreciate that the method 400 can be practiced with other embodiments of the present technology. Moreover, the steps described herein can be practiced in an order different from the order in which they are presented. The method 400 may also omit some of the steps described herein and/or include additional steps.

The method 400 begins at block 402 by receiving a request for content from an application (e.g., the central applications 322, the IFE applications 332) onboard an aircraft (e.g., the aircraft 102). The application can be on an onboard server of the aircraft or on an IFE device of the aircraft. The requested content can be multimedia content (e.g., movies, music, TV shows, etc.), flight tracking programs, recommended travel itineraries, shopping content, cabin data, etc.

At block 404, the method 400 continues by accessing a distributed storage system (e.g., the distributed storage system 304) on the aircraft. The distributed storage system can include one or more central databases (e.g., the central databases 328) included in one or more onboard servers (e.g., the onboard servers 320) on the aircraft, and one or more in-flight entertainment (IFE) databases (e.g., the IFE databases 338) included in one or more IFE devices (e.g., the IFE devices 108) on the aircraft.

At block 406, the method 400 continues by retrieving the requested content from at least one of the central databases and/or the IFE databases of the distributed storage system. At block 408, the method 400 continues by transferring the retrieved content to the application. In some implementations, content distribution network (CDN) nodes included in the onboard servers or the IFE devices (e.g., CDN nodes 324, CDN nodes 334) perform the steps of blocks 406 and/or 408.

In some implementations, the method 400 can further include anticipating requests for content by the application, determining that the distributed storage system does not store the content anticipated to be requested by the application, and receiving the content anticipated to be requested by the application from one or more ground servers (e.g., the ground servers 114).

In some implementations, the method 400 can further include receiving content from one or more ground servers, and determining in which of the central databases and/or the IFE databases to store the received content. In some implementations, determining in which of the central databases and/or the IFE databases to store the received content is based on at least one of a type of the received content, a file size of the received content, remaining storage space on the central databases, or remaining storage space on the IFE databases.

In some implementations, the method 400 can further include determining that the distributed storage system does not store the requested content, and submitting a cache miss request to a processor (e.g., the CDN ingest manager 326) included in the one or more onboard servers. The processor can be configured to, in response to the cache miss request, retrieve the requested content from one or more ground servers.

In some implementations, the method 400 can further include determining that the requested content is available on at least one of the central databases and/or the IFE databases of the distributed storage system.

In accordance with the disclosed technology herein, some preferred embodiments may incorporate technical solutions as indicated in the following examples:

1. A content distribution network system for an aircraft (e.g., as described with respect to FIG. 1 and FIG. 3), the system comprising: one or more onboard servers on the aircraft, each of the onboard servers comprising one or more central applications; a first content distribution network (CDN) node operably coupled to the one or more central applications; and a central database operably coupled to the first CDN node; and one or more in-flight-entertainment (IFE) devices on the aircraft. Each of the IFE devices comprises one or more IFE applications; a second CDN node operably coupled to the one or more IFE applications; and an IFE database operably coupled to the second CDN node. The central databases and the IFE databases form a distributed storage system. The distributed storage system is configured to store multimedia content and/or packets of multimedia content in one or more of the central databases and/or the IFE databases. The one or more central applications are configured to access the distributed storage system via the first and/or second CDN nodes. The one or more IFE applications are configured to access the distributed storage system via the first and/or second CDN nodes.

2. The system of any one of the examples herein, wherein at least one of the one or more onboard servers further comprises a CDN ingest manager operably coupled to the first CDN node and the distributed storage system, wherein the CDN ingest manager includes: a communication module configured to receive content from one or more ground servers; and a processor operably coupled to the communication module and configured to determine in which of the central databases and/or the IFE databases the content received by the communication module is to be stored.

3. The system of any one of the examples herein, wherein the processor of the CDN ingest manager is further configured to: anticipate requests for content from the one or more central applications and/or the one or more IFE applications; determine that the distributed storage system does not store the content anticipated to be requested by the one or more central applications and/or the one or more IFE applications; and receive the content anticipated to be requested by the one or more central applications and/or the one or more IFE applications from the one or more ground servers.

4. The system of any one of the examples herein, wherein the processor of the CDN ingest manager is further configured to: anticipate requests for content from the one or more central applications and/or the one or more IFE applications; and determine that the distributed storage system does store the content anticipated to be requested by the one or more central applications and/or the one or more IFE applications.

5. The system of any one of the examples herein, wherein the processor of the CDN ingest manager is further configured to segment the content received by the communication module into a plurality of segments and store the segments in one or more of the central databases and/or the IFE databases.

6. The system of any one of the examples herein, wherein the CDN ingest manager includes a machine learning model trained to anticipate requests for content by the one or more central applications and/or the one or more IFE applications based on at least one of passenger data or flight route of the aircraft.

7. The system of any one of the examples herein, wherein at least one of the one or more onboard servers further comprises a CDN ingest manager operably coupled to the first CDN node and the distributed storage system, wherein the first CDN node is configured to: receive a request for content from the one or more central applications and/or the one or more IFE applications; determine that the distributed storage system does not store the content requested; and submit a cache miss request to the CDN ingest manager.

8. The system of any one of the examples herein, wherein the CDN ingest manager is configured to, in response to the cache miss request, retrieve the content requested from one or more ground servers.

9. The system of any one of the examples herein, wherein each of the first and second CDN nodes is configured to: receive a request for content from the one or more central applications and/or the one or more IFE applications; determine that the distributed storage system does store the content requested; and transfer the content requested from at least one of the central databases and/or the IFE databases to the one or more central applications and/or the one or more IFE applications.

10. The system of any one of the examples herein, wherein the first and second CDN nodes are operably coupled and synchronized such that each of the first and second CDN nodes can determine content stored in the central databases and in the IFE databases.

11. A distributed storage system onboard an aircraft (e.g., FIGS. 1 to 3), the system comprising: one or more central databases included in one or more onboard servers on the aircraft, wherein the central databases are operably coupled to a first content distribution network (CDN) node included in the one or more onboard servers; and one or more in-flight entertainment (IFE) databases included in one or more IFE devices on the aircraft, wherein the IFE databases are operably coupled to a second CDN node included in the one or more IFE devices, wherein the one or more central databases and the one or more IFE databases are configured to store multimedia content and/or packets of multimedia content, and wherein the one or more central databases and the one or more IFE databases are configured to provide requested content to applications included in at least one of the one or more onboard servers or the one or more IFE devices via the first and/or second CDN nodes.

12. The system of any one of the examples herein, wherein the one or more central databases and the one or more IFE databases are configured to receive content to store from ground servers through a processor included in the one or more onboard servers, wherein the processor is configured to determine in which of the central databases and/or the IFE databases the content received is to be stored.

13. The system of any one of the examples herein, wherein the first and second CDN nodes are operably coupled and synchronized such that each of the first and second CDN nodes can determine content stored in the central databases and in the IFE databases.

14. The system of any one of the examples herein, wherein the first and second CDN nodes provide a level of abstraction such that the applications included in at least one of the one or more onboard servers or the one or more IFE devices do not include compatibility features configured to access content stored in the system.

15. A method of operating a content distribution network system (e.g., FIG. 4) for an aircraft, the method comprising: receiving a request for content from an application onboard the aircraft; accessing a distributed storage system on the aircraft, wherein the distributed storage system comprises: one or more central databases included in one or more onboard servers on the aircraft; and one or more in-flight entertainment (IFE) databases included in one or more IFE devices on the aircraft; retrieving the requested content from at least one of the central databases and/or the IFE databases of the distributed storage system; and transferring the retrieved content to the application.

16. The method of any one of the examples herein, further comprising: anticipating requests for content by the application; determining that the distributed storage system does not store the content anticipated to be requested by the application; and receiving the content anticipated to be requested by the application from one or more ground servers.

17. The method of any one of the examples herein, further comprising: receiving content from one or more ground servers; and determining in which of the central databases and/or the IFE databases to store the received content.

18. The method of any one of the examples herein, wherein determining in which of the central databases and/or the IFE databases to store the received content is based on at least one of a type of the received content, a file size of the received content, remaining storage space on the central databases, or remaining storage space on the IFE databases.

19. The method of any one of the examples herein, further comprising: determining that the distributed storage system does not store the requested content; and submitting a cache miss request to a processor included in the one or more onboard servers, wherein the processor is configured to, in response to the cache miss request, retrieve the requested content from one or more ground servers.

20. The method of any one of the examples herein, further comprising: determining that the requested content is available on at least one of the central databases and/or the IFE databases of the distributed storage system.

### 6. Concluding Remarks

It will be appreciated by one of skill in the art that the present document discloses techniques that may be used to solve practical problems related to storage and distribution of multimedia data on an aircraft. In one example aspect, onboard caching is performed of data that, in prior art systems, would have to be retrieved from a storage that is off-site to the airplane. Furthermore, this data may be cached in a distributed manner. The disclosed arrangement therefore results in saving of valuable communication resources and further reduces computing and other electro-mechanical (e.g., cooling and storage weight and size) resource needed to provide a satisfactory user experience during travel.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

1. A content distribution network system for an aircraft, the system comprising:
one or more onboard servers on the aircraft, each of the onboard servers comprising:
one or more central applications;
a first content distribution network (CDN) node operably coupled to the one or more central applications; and
a central database operably coupled to the first CDN node; and
one or more in-flight-entertainment (IFE) devices on the aircraft, each of the IFE devices comprising:
one or more IFE applications;
a second CDN node operably coupled to the one or more IFE applications; and
an IFE database operably coupled to the second CDN node,
wherein the central databases and the IFE databases form a distributed storage system,
wherein the distributed storage system is configured to store multimedia content and/or packets of multimedia content in one or more of the central databases and/or the IFE databases,
wherein the one or more central applications are configured to access the distributed storage system via the first and/or second CDN nodes, and
wherein the one or more IFE applications are configured to access the distributed storage system via the first and/or second CDN nodes.

2. The system of claim 1, wherein at least one of the one or more onboard servers further comprises a CDN ingest manager operably coupled to the first CDN node and the distributed storage system, wherein the CDN ingest manager includes:
a communication module configured to receive content from one or more ground servers; and
a processor operably coupled to the communication module and configured to determine in which of the central databases and/or the IFE databases the content received by the communication module is to be stored.

3. The system of claim 2, wherein the processor of the CDN ingest manager is further configured to:
anticipate requests for content from the one or more central applications and/or the one or more IFE applications;
determine that the distributed storage system does not store the content anticipated to be requested by the one or more central applications and/or the one or more IFE applications; and
receive the content anticipated to be requested by the one or more central applications and/or the one or more IFE applications from the one or more ground servers.

4. The system of claim 2, wherein the processor of the CDN ingest manager is further configured to:
anticipate requests for content from the one or more central applications and/or the one or more IFE applications; and
determine that the distributed storage system does store the content anticipated to be requested by the one or more central applications and/or the one or more IFE applications.

5. The system of claim 2, wherein the processor of the CDN ingest manager is further configured to segment the content received by the communication module into a plurality of segments and store the segments in one or more of the central databases and/or the IFE databases.

6. The system of claim 2, wherein the CDN ingest manager includes a machine learning model trained to anticipate requests for content by the one or more central applications and/or the one or more IFE applications based on at least one of passenger data or flight route of the aircraft.

7. The system of claim 1, wherein at least one of the one or more onboard servers further comprises a CDN ingest manager operably coupled to the first CDN node and the distributed storage system, wherein the first CDN node is configured to:
receive a request for content from the one or more central applications and/or the one or more IFE applications;
determine that the distributed storage system does not store the content requested; and
submit a cache miss request to the CDN ingest manager.

8. The system of claim 7, wherein the CDN ingest manager is configured to, in response to the cache miss request, retrieve the content requested from one or more ground servers.

9. The system of claim 1, wherein each of the first and second CDN nodes is configured to:
receive a request for content from the one or more central applications and/or the one or more IFE applications;
determine that the distributed storage system does store the content requested; and
transfer the content requested from at least one of the central databases and/or the IFE databases to the one or more central applications and/or the one or more IFE applications.

10. The system of claim 1, wherein the first and second CDN nodes are operably coupled and synchronized such that each of the first and second CDN nodes can determine content stored in the central databases and in the IFE databases.

11. A distributed storage system onboard an aircraft, the system comprising:
one or more central databases included in one or more onboard servers on the aircraft, wherein the central databases are operably coupled to a first content distribution network (CDN) node included in the one or more onboard servers; and
one or more in-flight entertainment (IFE) databases included in one or more IFE devices on the aircraft, wherein the IFE databases are operably coupled to a second CDN node included in the one or more IFE devices,
wherein the one or more central databases and the one or more IFE databases are configured to store multimedia content and/or packets of multimedia content, and
wherein the one or more central databases and the one or more IFE databases are configured to provide requested content to applications included in at least one of the one or more onboard servers or the one or more IFE devices via the first and/or second CDN nodes.

12. The system of claim 11, wherein the one or more central databases and the one or more IFE databases are configured to receive content to store from ground servers through a processor included in the one or more onboard servers, wherein the processor is configured to determine in which of the central databases and/or the IFE databases the content received is to be stored.

13. The system of claim 11, wherein the first and second CDN nodes are operably coupled and synchronized such that each of the first and second CDN nodes can determine content stored in the central databases and in the IFE databases.

14. The system of claim 11, wherein the first and second CDN nodes provide a level of abstraction such that the applications included in at least one of the one or more onboard servers or the one or more IFE devices do not include compatibility features configured to access content stored in the system.

15. A method of operating a content distribution network system for an aircraft, the method comprising:
receiving a request for content from an application onboard the aircraft;
accessing a distributed storage system on the aircraft, wherein the distributed storage system comprises:
one or more central databases included in one or more onboard servers on the aircraft; and
one or more in-flight entertainment (IFE) databases included in one or more IFE devices on the aircraft;
retrieving the requested content from at least one of the central databases and/or the IFE databases of the distributed storage system; and
transferring the retrieved content to the application.

16. The method of claim 15, further comprising:
anticipating requests for content by the application;
determining that the distributed storage system does not store the content anticipated to be requested by the application; and
receiving the content anticipated to be requested by the application from one or more ground servers.

17. The method of claim 15, further comprising:
receiving content from one or more ground servers; and
determining in which of the central databases and/or the IFE databases to store the received content.

18. The method of claim 17, wherein determining in which of the central databases and/or the IFE databases to store the received content is based on at least one of a type of the received content, a file size of the received content, remaining storage space on the central databases, or remaining storage space on the IFE databases.

19. The method of claim 15, further comprising:
determining that the distributed storage system does not store the requested content; and
submitting a cache miss request to a processor included in the one or more onboard servers, wherein the processor is configured to, in response to the cache miss request, retrieve the requested content from one or more ground servers.

20. The method of claim 15, further comprising:
determining that the requested content is available on at least one of the central databases and/or the IFE databases of the distributed storage system.
